(19) United States
(12) Patent Application Publication
(10) Pub. No.: US 2021/0127273 A1
(43) Pub. Date: Apr. 29, 2021

(54) ENHANCED BEACON PROTECTION REKEYING AND ATTACK DETECTION FOR WIRELESS COMMUNICATIONS

(71) Applicants: Ido Ouzieli, Tel Aviv (IL); Johannes Berg, Detmold (DE); Stanislav Gens, Nazareth Illit (IL); Emily H. Qi, Gig Harbor, WA (US); Izoslav Tchigevsky, Haifa (IL)

(72) Inventors: Ido Ouzieli, Tel Aviv (IL); Johannes Berg, Detmold (DE); Stanislav Gens, Nazareth Illit (IL); Emily H. Qi, Gig Harbor, WA (US); Izoslav Tchigevsky, Haifa (IL)

(21) Appl. No.: 17/117,265

(22) Filed: Dec. 10, 2020

Related U.S. Application Data
(60) Provisional application No. 62/946,761, filed on Dec. 11, 2019.
(60) Provisional application No. 62/946,063, filed on Dec. 10, 2019.

(51) Int. Cl. H04W 12/122; H04W 12/10; H04W 12/0433

(52) U.S. Cl. CPC H04W 12/122; H04W 12/0433; H04W 12/10

(57) ABSTRACT

This disclosure describes systems, methods, and devices related to beacon protection rekeying and attack detection. A device may set a first beacon integrity group transient key (BIGTK). The device may generate a first frame including a first indication of a second BIGTK to be used for a first integrity analysis of the first frame, a second indication of the first BIGTK, and a third indication that the first BIGTK is to be used for a second integrity analysis of a second frame to be sent after the first frame. The device may send the first frame, and may generate the second frame, the second frame including an indication that the first BIGTK is to be used for the second integrity analysis of the second frame. The device may send the second frame.

### CROSS-REFERENCE TO RELATED APPLICATIONS

This application is related to and claims priority to U.S. Provisional Patent Application No. 62/946,761, filed Dec. 11, 2019, and to U.S. Provisional Patent Application No. 62/946,063, filed Dec. 10, 2019, which are hereby incorporated herein by reference in their entirety.

### TECHNICAL FIELD

This disclosure generally relates to systems and methods for wireless communications and, more particularly, to beacon protection rekeying mechanism and attack detection.

### BACKGROUND

Wireless devices are becoming widely prevalent and are increasingly requesting access to wireless channels. The Institute of Electrical and Electronics Engineers (IEEE) is developing one or more standards that utilize Orthogonal Frequency-Division Multiple Access (OFDMA) in channel allocation.

### BRIEF DESCRIPTION OF THE DRAWINGS

FIG. 1 is a network diagram illustrating an example network environment, in accordance with one or more example embodiments of the present disclosure.

FIG. 2A depicts an illustrative group-addressed frame, in accordance with one or more example embodiments of the present disclosure.

FIG. 2B depicts an illustrative protected beacon frame, in accordance with one or more example embodiments of the present disclosure.

FIG. 3 depicts an illustrative process for switching beacon integrity group temporal keys, in accordance with one or more example embodiments of the present disclosure.

FIG. 4 depicts an illustrative process for device authentication and association, in accordance with one or more example embodiments of the present disclosure.

FIG. 5 illustrates a flow diagram of illustrative process for beacon protection rekeying, in accordance with one or more example embodiments of the present disclosure.

FIG. 6 illustrates a functional diagram of an exemplary communication station that may be suitable for use as a user device, in accordance with one or more example embodiments of the present disclosure.

FIG. 7 illustrates a block diagram of an example machine upon which any of one or more techniques (e.g., methods) may be performed, in accordance with one or more example embodiments of the present disclosure.

FIG. 8 is a block diagram of a radio architecture in accordance with some examples.

FIG. 9 illustrates an example front-end module circuitry for use in the radio architecture of FIG. 8, in accordance with one or more example embodiments of the present disclosure.

FIG. 10 illustrates an example radio IC circuitry for use in the radio architecture of FIG. 8, in accordance with one or more example embodiments of the present disclosure.

FIG. 11 illustrates an example baseband processing circuitry for use in the radio architecture of FIG. 8, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

In wireless communication defined by the IEEE 802.11 technical standards, beacons (or beacon frames) are frames are a type of management frame that includes information about a wireless network. An access point (AP) may send beacons to announce the presence of wireless networks facilitated by the AP and to synchronize members of a service set. To protect beacons, a beacon integrity group temporal key (BIGTK) may be added to beacons to allow any station devices (STAs) to perform an integrity check (e.g., analysis) on any received beacon.

When a STA joins a service set facilitated by an AP, the STA and the AP perform a process that includes device authentication and device association. As part of the association process with a new STA, the AP may implement a four-way handshake process as defined by the IEEE 802.11 technical standards. Because of the four-way handshake exchange, both the AP and the STA may possess a BIGTK that is shared by all associated STAs and is used by the AP and the STAs for calculating a Management Integrity Check (MIC) value over a beacon, using a cipher-based message authentication code (CMAC) or a Galois message authentication code (GMAC) cipher suite. The AP and STAs may possess multiple BIGTK values (e.g., the BIGTK values having matching KeyIDs, such as KeyIDs 6 and 7).

As part of the four-way handshake exchange, the AP updates the STA with the Key ID and corresponding value of the currently used BIGTK. Because the BIGTK is shared by all associated STAs, the AP may update the BIGTK value on a regular basis as well as when an STA disassociates from AP. When the AP is to update the BIGTK, the AP may use a GTK rekeying mechanism (e.g., as defined by the IEEE 802.11 technical standards) to inform all the associated STAs (one at a time) of the new BIGTK value. The update may be achieved by first updating all associated STAs (one by one, e.g., using unicast GTK rekeying messages per STA) on a new value for one of the non-used GTKs and a new value for the non-used BIGTK. For example: The GTK which corresponds with KeyID 2 is the currently active GTK—AP may update all STAs on a new GTK value for KeyID 3. The BIGTK which corresponds with KeyID 6 is the currently active GTK—AP may update all STAs on a new IGTK value for KeyID 7. Once the new non-active BIGTK (e.g. KeyID 7) is set in all STAs, the AP may start using the new key as the “active” BIGTK for subsequent beacons. The above process results in a delay between the time the new keys were set by the AP in the STA and the time when AP actually starts using the new keys instead of the old ones.

In some group-addressed data frame transmissions defined by the IEEE 802.11 technical standards, the used GTK Key ID is indicated in the beginning of the frame (e.g., using a Key ID field in a Counter Mode Cipher Block Chaining Message Authentication Code Protocol—CCMP—header), so the STA knows early within the beacon which GTK to use in the integrity check for the beacon. However, in beacons, the KeyID is included toward the end of the beacon frame body, along with a management integrity check (MIC) for a beacon. In particular, the problem with the above GTK rekeying mechanism is that for protected beacons, the Key ID is reported in the Management MIC Information Element (MMIE), which is located at the end of the protected beacon. Therefore, when receiving a protected beacon, the receiving STA will identify the relevant Key ID only after the entire frame was received and the MIC was already calculated. In the case of BIGTK rekeying, the receiving STA has no idea when the AP starts using the new BIGTK, and therefore the STA may still use the old BIGTK and discover at the end of the frame that the AP switched to the new key (and vice-versa), resulting with re-calculation of the MIC of the entire frame. Because the beacon may be long in length/duration, the recalculation penalty is vast (e.g., time is wasted to recalculate the MIC). One result may be that STA implementations need to support special mechanisms to re-push a protected beacon into the hardware for CMAC or GMAC machines to re-calculate the MIC using the new BIGTK. Alternatively, STAs may use software support for CMAC/GMAC ciphers for calculating the MIC in software in case the BIGTK was updated and the hardware result MIC result may be based on the old BIGTK.

Wireless communications defined by the IEEE 802.11 technical standards also may be subjected to attempted attacks, such as man-in-the-middle attacks. One process where attackers may attempt such an attack is during device association. In particular, attackers may attempt to use a re-association request to an AP to perpetrate an attack. For example, a STA that has associated with an AP may need to re-associate with the AP. To re-associate, the STA may send a re-authentication request to the AP, and once re-authenticated (e.g., as indicated by a re-association response sent by the AP), the STA may send a re-association request to the AP. However, when the AP is unaware that the STA left a service set, the AP may have information indicating that the STA already is associated with the AP. Currently, instead of simply rejecting a re-association request, the AP may send a temporary rejection with a ResultCode REFUSED_TEMPORARILY and TimeoutInterval indicating when the STA can try to re-associate again. The AP provides the temporary rejection because if the AP receives a re-association request from an STA with which the AP has an active security association with active management frame protection, the AP may suspect that the re-association-request was transmitted by a man-in-the-middle and not from the previously associated STA. However, it is possible that the real STA was disconnected from the AP and is trying to re-associate. For this reason, the AP may use the temporary rejection.

During the TimeoutInterval, the AP applies a security association (SA) query procedure: The AP transmits a protected SA Query Request to the STA, and waits for an SA Query Response. If an SA Query Response frame is received, the response indicates that the STA still holds the keys (otherwise, it could not decrypt the protected SA Query Request frame) and is still connected. Also, if an SA Query Response frame is received, the response indicates that the re-association request was generated by a man-in-the-middle and should have been rejected. If the re-association request was accepted, it may cause the real STA to lose sync with the security material, which may result with disconnection (e.g., a simple attack). If a future re-association request is received, the AP may reject the request again and repeat the SA Query procedure. If an SA Query Response frame is not received: The STA really lost the keys (e.g., because the keys were lost the STA could not decrypt the protected SA Query message, and as a result, no response was generated). When a future non-protected re-association request is received from an STA (e.g., probably following the TimeoutInterval), the AP may accept the request.

The above SA Query procedure may be activated when the re-association request is received. However, the above SA Query is not activated when an authentication request is received (e.g., the authentication preceding the association). A re-association request is typically preceded by an authentication request. However, until recent security mechanisms were added, the authentication process was not used efficiently, and therefore there was no motivation to initiate the SA Query procedure during the authentication step (i.e., before the re-association request is received).

Starting with simultaneous authentication of equals (SAE), fast transition (FT), and fast initial link setup (FILS) authentication, the authentication process has a significant impact on the current key material, and if initiated when not needed, it may cause the real STA to lose sync with the security material, which may result with disconnection (i.e., a simple attack). For example: An STA is associated with the AP with SAE Authentication and management frame protection. A man-in-the-middle (e.g., pretending to be the real STA) transmits an authentication request frame of type SAE to the AP. The AP may accept the authentication request and apply SAE authentication with the STA. SAE Authentication is completed successfully. Because SAE is based on a passphrase that may be publicly-displayed, the attack may be a realistic scenario. Following successful SAE Authentication, the AP updates its key material. A man-in-the-middle transmits a re-association request to the AP. Following reception of the re-association request, the AP may apply the SA Query mechanism, which will fail. However, significant time is consumed using the authentication procedure. Keys that are needed were probably deleted (e.g., depending on AP behavior), and the real STA will not be able to communicate, as the STA may be using non-relevant (e.g., outdated) keys.

There is therefore a need for a BIGTK key switching process and for a more efficient attack-detection process when using device authentication and device association.

Example embodiments of the present disclosure relate to systems, methods, and devices for beacon protection rekeying and device attack detection.

In one or more embodiments, after GTK rekeying (e.g., an AP changes the BIGTK Key ID and value), while the AP is still using the old BIGTK key, which is used by STAs to determine a MIC field of a beacon using the CMAC/GMAC algorithm, the AP may notify any associated STAs of the expected beacon or time when the AP will start using the new BIGTK. This mechanism will prevent sync errors between AP and STAs regarding which key to use. By using this mechanism, devices may not be required to support complicated cipher suites or complicated “hardware loop” mechanisms for corner cases scenarios. The beacon protection rekeying process may use one of several options.

In one or more embodiments, one way for an AP to notify STAs in advance of an upcoming switch to another BIGTK is to add a new information element—a BIGTK Switch Announcement—to a protected beacon. The BIGTK Switch Announcement may include multiple fields, such as a new key ID field that includes the new Key ID, and a BIGTK Switch Count field that indicates that the AP will switch the BIGTK after X beacons (e.g., X more beacons until the switch occurs). When X is greater than one, the AP may send multiple beacons with the current/old BIGTK, decrementing X by one in each beacon until X is one, meaning that the beacon with the BIGTK Switch Count field having a value of one is the final beacon that the AP will send with the current/old BIGTK, and that the next beacon that the AP will send will include the new BIGTK value as indicated by the new key ID field. The BIGTK Switch Announcement information element may or may not be included in beacons that follow the beacon with the BIGTK Switch Count field of value one unless the AP is planning another BIGTK switch (e.g., back to the previous BIGTK value). Using this mechanism, the STAs will know in advance when the new BIGTK is going to be used. Because the BIGTK is shared by all STAs, the BIGTK Switch may occur in parallel for all STAs. Therefore the ‘switch’ indication may not be station by station. The advantage of the suggested BIGTK Switch Announcement information element mechanism may be that all STAs are notified in parallel on expected change. Even if some of the STAs miss part of the beacons with the BIGTK Switch Announcement (e.g., due to power-save mechanisms), the mechanism allows for a STA to receive only one of the beacons to stay synched with the switch.

In one or more embodiments, another way for an AP to notify STAs in advance of an upcoming switch to another BIGTK is to add a new information element—a BIGTK Switch Announcement—to a protected beacon. Instead of the BIGTK Switch Announcement including the new key ID field and the BIGTK Switch Count field as described in the option above, the BIGTK Switch Count field may be replaced with a BIGTK Switch Timestamp field that indicates the time when the AP will begin to use the new BIGTK in other beacons. The BIGTK Switch Timestamp field may be included in multiple beacons until the switch, so any STA may determine the time remaining until the switch. The BIGTK Switch Timestamp field may be six octets in length, but may only need the three least significant octets when the switch is to occur within a few beacon intervals (e.g., the time between respective beacons). Using the BIGTK Switch Announcement, the AP may indicate that the AP is going to start using the new key (e.g., indicated by the new key ID field) when a beacon with a BIGTK Switch Timestamp that is higher than the reported Timestamp is received. Starting with a following Beacon, protected beacons may be protected with the new BIGTK (e.g., that was indicated by the new key ID field). After the AP decides to switch to a new BIGTK and has reported the upcoming switch to the STAs, the AP may continue to include the BIGTK Switch Announcement in all beacons until the switch operation is activated. Using this mechanism, the STAs will know in advance when the new BIGTK is going to be used. Since the BIGTK is shared by all STAs, the BIGTK switch may happen in parallel for all STAs. Therefore the switch indication may not be station by station. The advantage of the suggested BIGTK Switch Announcement mechanism may be that all STAs are notified in parallel of the expected change. Even if some of the STAs miss part of the beacons with the BIGTK Switch Announcement (e.g., due to power-save mechanisms), the mechanism may allow a STA to receive only one of the beacons to stay synched with the switch.

In one or more embodiments, another way for an AP to notify STAs in advance of an upcoming switch to another BIGTK is to use a BIGTK rekeying extensible authentication protocol over local area network (EAPOL) key frame (e.g., as defined by the IEEE 802.11 technical standards). For example, the EAPOL key frame may include multiple fields, such as a key MIC field, followed by a key data length field, followed by a key data field. When AP intends to switch to the new BIGTK key (e.g., following the installation/update of new GTK and BIGTK in all STAs), the AP may install the new key in each of the associated STAs by transmitting a dedicated BIGTK rekeying EAPOL. When installing the new key in the STA, the AP may include within the EAPOL a new BIGTK Switch Timestamp, which may indicate the time when the AP will switch to the new key. The BIGTK rekeying EAPOL may include an eight-octet key data encapsulation (KDE—used for including data in the EAPOL-key data field) that may indicate the time where the AP plans to switch to the new key. Following the EAPOL key frame timestamp, protected beacons may be protected with the new BIGTK.

In one or more embodiments, attack detection may be enhanced by using the SA query mechanism earlier in the association process than currently used. When receiving an SAE/FT authentication request from an STA that is assumed to be connected, the AP may start the SA query mechanism at an earlier stage, (e.g., immediately following the SAE authentication request, instead of waiting for the re-association-request). By using this mechanism, the AP may avoid a wasted SAE/FT Procedure that consumes time, and may prevent scenarios that cause the real STA to lose sync with the real key-material.

In one or more embodiments, while the AP is associated with an STA with active management frame protection, if the AP receives an authentication request (e.g., authentication message with an authentication transaction sequence number set to 1) in which the authentication algorithm is SAE, FT or FILS, the AP may reject the authentication request, and may transmit an authentication response (e.g., an authentication message with an authentication transaction sequence number set to 2) with status code 30—REFUSED_TEMPORARILY (e.g., indicating that the association/authentication request is rejected temporarily), and may include the TimeoutInterval field. In addition, the AP may follow the SA query procedure, in the same manner as when receiving a re-association request from an STA with which the AP has a valid security association with active management frame protection. The AP may transmit a protected SA query request frame to the STA, and wait for an SA query response frame. If an SA query response is received by the AP, it indicates that the STA is still connected and has the keys so that it can decrypt the protected SA query request frame. Therefore, the previous authentication request may have been generated by a man-in-the-middle attacker. If a future authentication request is received again from the STA, the AP may reject the request again and may repeat the SA query procedure. If an SA query response is not received during the TimeoutInterval, such may indicate that the STA was disconnected from the AP and lost the keys (e.g., because the keys were lost, the STA could not decrypt the protected SA query message, and as a result, no response was generated). If a future authentication request is received, the AP may accept the request, and also may accept the re-association request which may follow.

In one or more embodiments, there may be a backwards compatibility issue. A legacy STA may not understand the authentication response with status code 30—REFUSED_TEMPORARILY and the TimeoutInterval field. Previously, status code 30 was linked only to an association response and not to an authentication response. A legacy STA may not understand the authentication rejection reason, and therefore may not attempt to re-authenticate with the AP following the SA query timeout. To solve the backwards compatibility issue, the STA may indicate its support for this new mechanism via a dedicated bit in the RSNXE (RSN Extension element) which is already included by the STA in the association request and the four-way-handshake (e.g., using the second message) defined by the IEEE 802.11 standards. While the AP is already associated with an STA that indicated ‘Authentication try again later’ support via RSNXE, the AP may reject new SAE/FT/FILS authentication requests with a “try again later” (e.g., status code 30) as described above. However, if the AP is already associated with an STA that did not indicate ‘Authentication try again later’ support (e.g., either RSNXE was not included, or RSNXE is included but the relevant capability bit is not set), the AP may behave as it does prior to this disclosure.

In one or more embodiments, once a STA transmits a protected Beacon frame using a new BIGTK, the STA may not transmit protected Beacon frames using the previous BIGTK (e.g., once the switch to the updated BIGTK occurs, protected beacons may not use the previously included BIGTK, unless another switch occurs, for example). Once a STA transmits a protected group addressed robust Management frame using a new IGTK, the STA may not transmit protected group addressed robust Management frames using the previously used IGTK.

In one or more embodiments, instead of trying to start SA Query more early, the SA Query may be removed in cases where an Authentication frame exchange may prove that the STA is the correct one (e.g., the STA may complete full authentication) and is not an attacker (e.g., trying to perform a denial-of-service). The SA Query in these cases may not be necessary and may be adding undesired extra latency.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

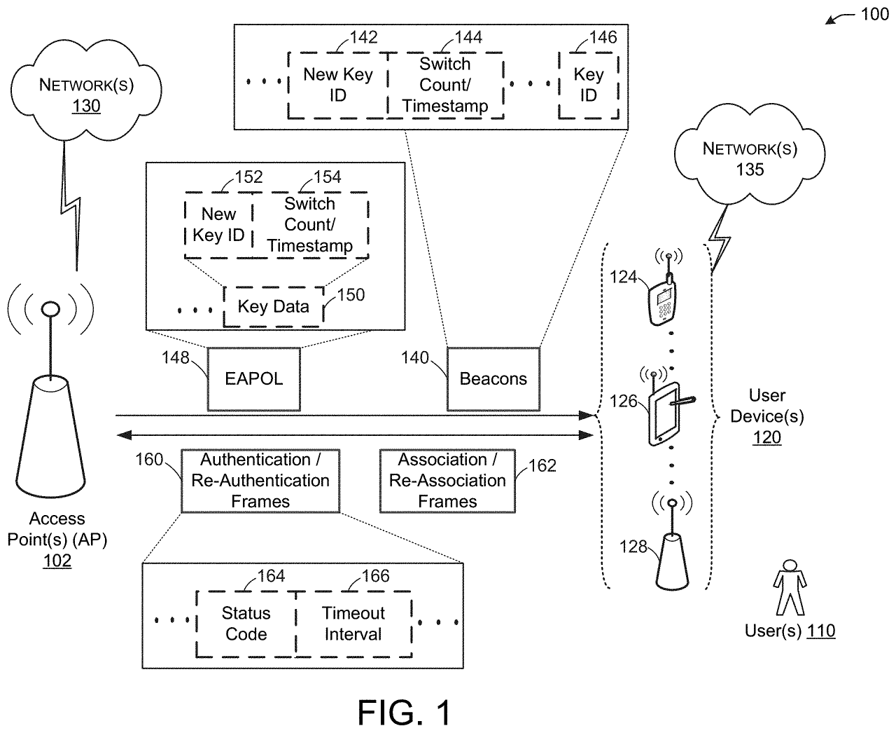

FIG. 1 is a network diagram illustrating an example network environment of synched beacon protection rekeying, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

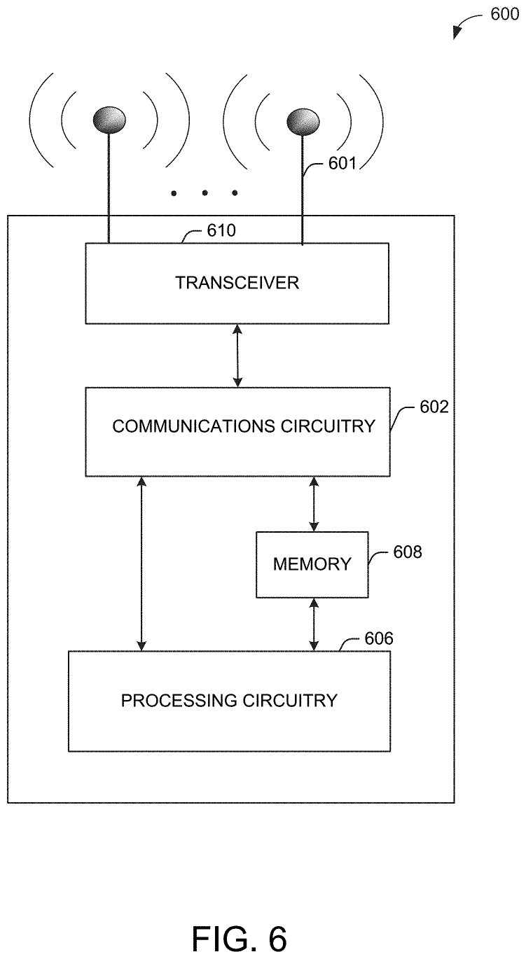

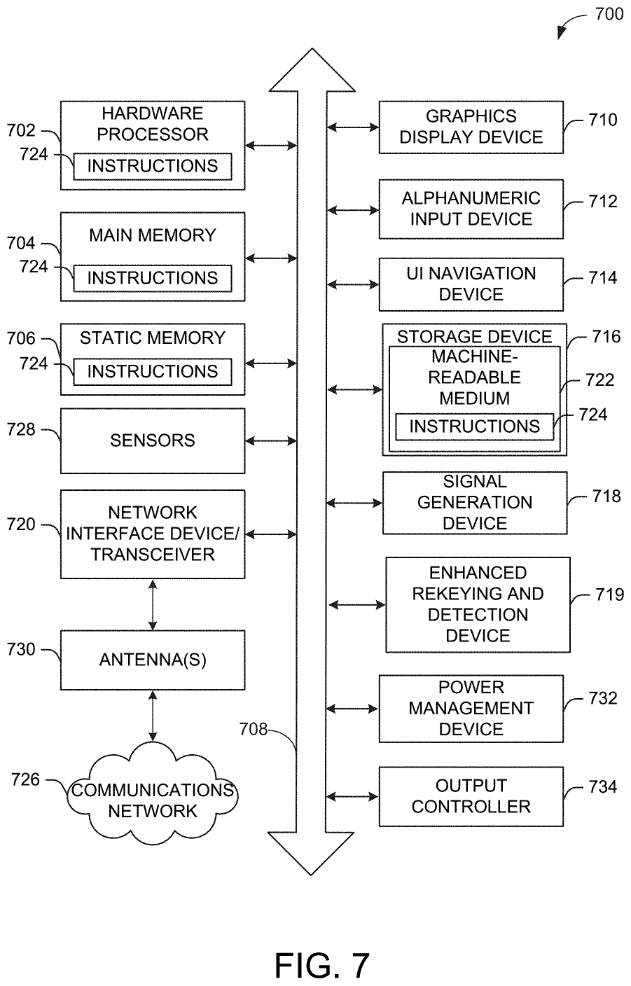

In some embodiments, the user devices 120 and the AP 102 may include one or more computer systems similar to that of the functional diagram of FIG. 6 and/or the example machine/system of FIG. 7.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

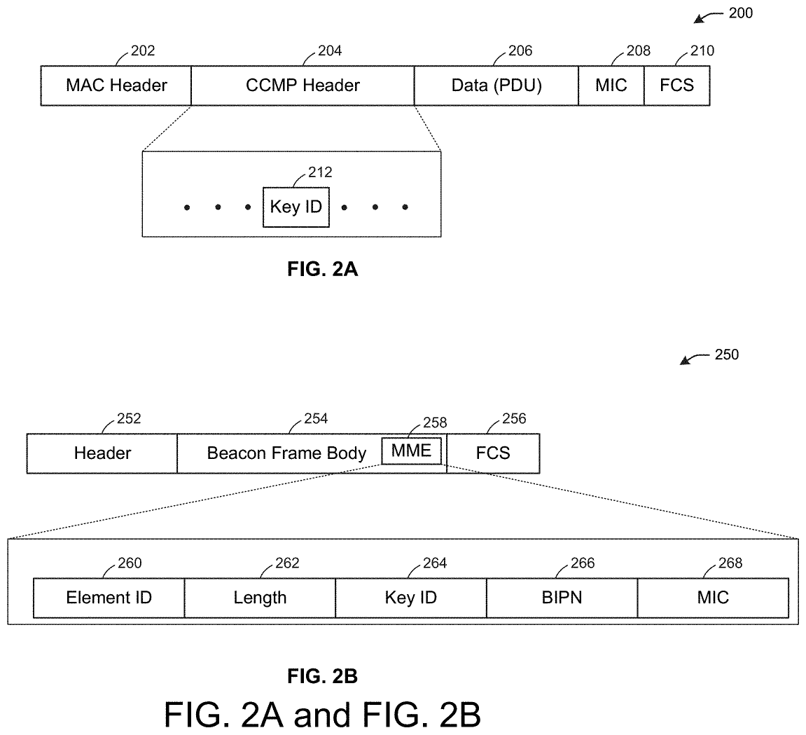

In one embodiment, and with reference to FIG. 1, AP 102 may facilitate synched beacon protection rekeying with the one or more user devices 120. In particular, the AP 102 may send beacons 140 to the one or more user devices 120. After GTK rekeying (e.g., the AP 102 changes the BIGTK Key ID and value), while the AP 102 is still using the old BIGTK key, which is used by the one or more user devices 120 to determine a MIC field (e.g., see FIG. 2B) of one of the beacons 140 using the CMAC/GMAC algorithm, the AP 102 may notify the one or more user devices 120 of the expected beacon or time when the AP 102 will start using the new BIGTK. The beacon protection rekeying process may use one of several options.

In one or more embodiments, one way for an AP 102 to notify the one or more user devices 120 in advance of an upcoming switch to another BIGTK is to add a new information element—a BIGTK Switch Announcement—to a protected beacon. The BIGTK Switch Announcement may include multiple fields, such as a new key ID field 142 that includes the new Key ID, and a BIGTK Switch Count/Timestamp field 144 that indicates that the AP 102 will switch the BIGTK after X beacons (e.g., X more beacons until the switch occurs). When X is greater than one, the AP 102 may send multiple beacons with the current/old BIGTK, decrementing X by one in each beacon until X is one, meaning that the beacon with the BIGTK Switch Count/Timestamp field 144 having a value of one is the final beacon that the AP102 will send with the current/old BIGTK, and that the next beacon that the AP 102 will send will include the new BIGTK value as indicated by the new key ID field 142. The BIGTK Switch Announcement information element may or may not be included in beacons that follow the beacon with the BIGTK Switch Count/Timestamp field 144 of value one unless the AP 102 is planning another BIGTK switch (e.g., back to the previous BIGTK value). Using this mechanism, the one or more user devices 120 will know in advance when the new BIGTK is going to be used. Because the BIGTK is shared by all the one or more user devices 120, the BIGTK Switch may occur in parallel for all the one or more user devices 120. Therefore the ‘switch’ indication may not be station by station. The advantage of the suggested BIGTK Switch Announcement information element mechanism may be that all the one or more user devices 120 are notified in parallel on expected change. Even if some of the STAs miss part of the beacons 140 with the BIGTK Switch Announcement (e.g., due to power-save mechanisms), the mechanism allows for a STA to receive only one of the beacons 140 to stay synched with the switch. The beacons 140 may include the current key ID field 146 (e.g., the current BIGTK ID being used until the switch occurs).

In one or more embodiments, another way for an AP 102 to notify the one or more user devices 120 in advance of an upcoming switch to another BIGTK is to add a new information element—a BIGTK Switch Announcement—to a protected beacon. Instead of the BIGTK Switch Announcement including the new key ID field 142 and the BIGTK Switch Count/Timestamp field 144 as described in the option above (e.g., indicating the number of beacons before the switch is to occur), the BIGTK Switch Count/Timestamp field 144 may be replaced with a timestamp that indicates the time when the AP 102 will begin to use the new BIGTK in other beacons. The BIGTK Switch Count/Timestamp field 144 field may be included in multiple beacons until the switch, so any STA may determine the time remaining until the switch. The BIGTK Switch Count/Timestamp field 144 field may be six octets in length, but may only need the three least significant octets when the switch is to occur within a few beacon intervals (e.g., the time between respective beacons of the beacons 140). Using the BIGTK Switch Announcement, the AP 102 may indicate that the AP 102 is going to start using the new key (e.g., indicated by the new key ID field 142) when a beacon with a BIGTK Switch Count/Timestamp field 144 timestamp that is higher than the reported timestamp is received. Starting with a following beacon, protected beacons (e.g., the beacons 140) may be protected with the new BIGTK (e.g., that was indicated by the new key ID field 142). After the AP 102 decides to switch to a new BIGTK and has reported the upcoming switch to the user devices 120, the AP 102 may continue to include the BIGTK Switch Announcement in all beacons until the switch operation is activated. Using this mechanism, the user devices 120 will know in advance when the new BIGTK is going to be used. Since the BIGTK is shared by all the user devices 120, the BIGTK switch may happen in parallel for all the user devices 120. Therefore the switch indication may not be station by station. The advantage of the suggested BIGTK Switch Announcement mechanism may be that all the user devices 120 are notified in parallel of the expected change. Even if some of the user devices 120 miss part of the beacons with the BIGTK Switch Announcement (e.g., due to power-save mechanisms), the mechanism may allow a STA to receive only one of the beacons 140 to stay synched with the switch.

In one or more embodiments, another way for an AP 102 to notify the user devices 120 in advance of an upcoming switch to another BIGTK is to use a BIGTK rekeying EAPOL key frame 148 (e.g., as defined by the IEEE 802.11 technical standards). For example, the EAPOL key frame 148 may include multiple fields, such as a key MIC field (not shown), followed by a key data length field (not shown), followed by a key data field 150. When the AP 102 intends to switch to the new BIGTK key (e.g., following the installation/update of new GTK and BIGTK in all STAs), the AP 102 may install the new key in each of the associated user devices 120 by transmitting a dedicated BIGTK rekeying EAPOL 148. When installing the new key in the user devices 120, the AP 102 may include within the EAPOL frame 148 a new BIGTK Switch Count/Timestamp 154, which may indicate the time when the AP will switch to the new key (e.g., as indicated by the new key ID 152). The BIGTK rekeying EAPOL frame 148 may include an eight-octet key data encapsulation (KDE—used for including data in the EAPOL-key data field 150) that may indicate the time where the AP 102 plans to switch to the new key. Following the BIGTK Switch Count/Timestamp 154, protected beacons (e.g., of the beacons 140) may be protected with the new BIGTK.

In one or more embodiments, the AP 102 and the user devices 120 may exchange authentication/re-authentication frames 160 and may exchange association/re-association frames 162 (e.g., after exchanging the authentication/re-authentication frames 160 as part of an association or re-association process as defined by the IEEE 802.11 technical standards). To prevent attacks using re-authentication requests, when the AP 102 receives a re-authentication request (e.g., as part of the authentication/re-authentication frames 160) from one of the user devices 120 that the AP 102 identifies as a STA that is already associated with the AP 102, the AP 102 temporarily may reject the re-authentication request by including a status code field 164 (e.g., a status code 30 indication as described above) and a timeout interval field 166 in a re-authentication response frame (e.g., as part of the authentication/re-authentication frames 160) to the requesting STA of the user devices 120. The status code field 164 may include ResultCode REFUSED_TEMPORARILY, and the timeout interval field 166 may include a TimeoutInterval indicating when the STA can try to re-associate again. The AP 102 may provide the temporary rejection because if the AP 102 receives a re-association request from an STA with which the AP 102 has an active security association with active management frame protection, the AP 102 may suspect that the re-association-request was transmitted by a man-in-the-middle and not from the previously associated STA.

In one or more embodiments, during the TimeoutInterval indicated by the timeout interval field 166, the AP 102 may apply a security association (SA) query procedure: The AP 102 may transmit (e.g., as part of the authentication/re-authentication frames 160) a protected SA Query Request to the STA, and may wait for an SA Query Response (e.g., as part of the authentication/re-authentication frames 160). If an SA Query Response frame is received by the AP 102, the response indicates that the STA still holds the keys (otherwise, it could not decrypt the protected SA Query Request frame) and is still connected. Also, if an SA Query Response frame is received, the response indicates that the re-association request was generated by a man-in-the-middle and should have been rejected. If the re-association request was accepted, it may cause the real STA to lose sync with the security material, which may result with disconnection (e.g., a simple attack). If a future re-association request is received, the AP 102 may reject the request again and repeat the SA Query procedure. If an SA Query Response frame is not received: The STA really lost the keys (e.g., because the keys were lost the STA could not decrypt the protected SA Query message, and as a result, no response was generated). When a future non-protected re-association request is received from an STA (e.g., probably following the TimeoutInterval), the AP 102 may accept the request.

It is understood that the above descriptions are for purposes of illustration and are not meant to be limiting.

FIG. 2A depicts an illustrative group-addressed frame 200, in accordance with one or more example embodiments of the present disclosure.

Referring to FIG. 2, the group-addressed frame 200 may be used in communications defined by the IEEE 802.11 standards. For example, a device (e.g., the AP 102 of FIG. 1) may send the group-addressed frame 200 to multiple other devices (e.g., the user devices 120 of FIG. 1). In communications defined by the IEEE 802.11 standards, a data unit protected with counter mode (CTR) with cipher-block chaining message authentication code (CBC) protocol (CCMP) may be referred to as a CCMP data unit. The group-addressed frame 200 may represent a CCMP data unit, and may include multiple fields, such a medium access control (MAC) header 202, a CCMP header 204, data (protocol data unit—PDU) 206, a MIC 208, and a frame check sequence (FCS) 210. The CCMP header 204 may include multiple subfields, such as a key ID 212, which may be used to indicate the GTK key ID used for the group-addressed frame 200. In this manner, the GTK key ID may be identified by a receiving device (e.g., the user devices 120 of FIG. 1) toward the beginning of the group-addressed frame 200, so the receiving device quickly may identify the GTK to use for analyzing the group-addressed frame 200 (e.g., as opposed to processing more of the group-addressed frame 200 before identifying the GTK).

When rekeying for GTK, however, protected beacons (e.g., the beacons 140 of FIG. 1) indicate the key ID toward the end of a beacon (e.g., as shown in FIG. 2B).

FIG. 2B depicts an illustrative protected beacon frame 250, in accordance with one or more example embodiments of the present disclosure.

Referring to FIG. 2B, the protected beacon frame 250 may include multiple fields, including a header 252, a beacon frame body 254, and a FCS 256. At the end of the beacon frame body 254 may be a management MIC element (MME) 258 (also referred to as a management MIC information element—MMIE) used to indicate the key ID. A receiving device (e.g., the user devices 120 of FIG. 1) of the protected beacon frame 250 generally may begin a MIC calculation for the protected beacon frame 250 at the start of when the protected beacon frame 250 is received. Therefore, the receiving device may identify the relevant key ID only after the entire protected beacon frame 250 has been received and after calculating the MIC. When using BIGTK rekeying, the receiving device may not be aware of when the sending device (e.g., the AP 102 of FIG. 1) begins using a new BIGTK, so the receiving device may be using the “old” BIGTK when the receiving device receives the protected beacon frame 250, only to determine at the end of the protected beacon frame 250 (e.g., based on the location of the key ID in the protected beacon frame 250) that the sending device has switched to a different key, thereby requiring the receiving device to re-calculate the MIC for the entire protected beacon frame 250. Due to the length of the protected beacon frame 250 (e.g., more than 18 octets in length), the recalculation may result in wasted time. Therefore, the rekeying may be indicated in advance using one of the options described herein.

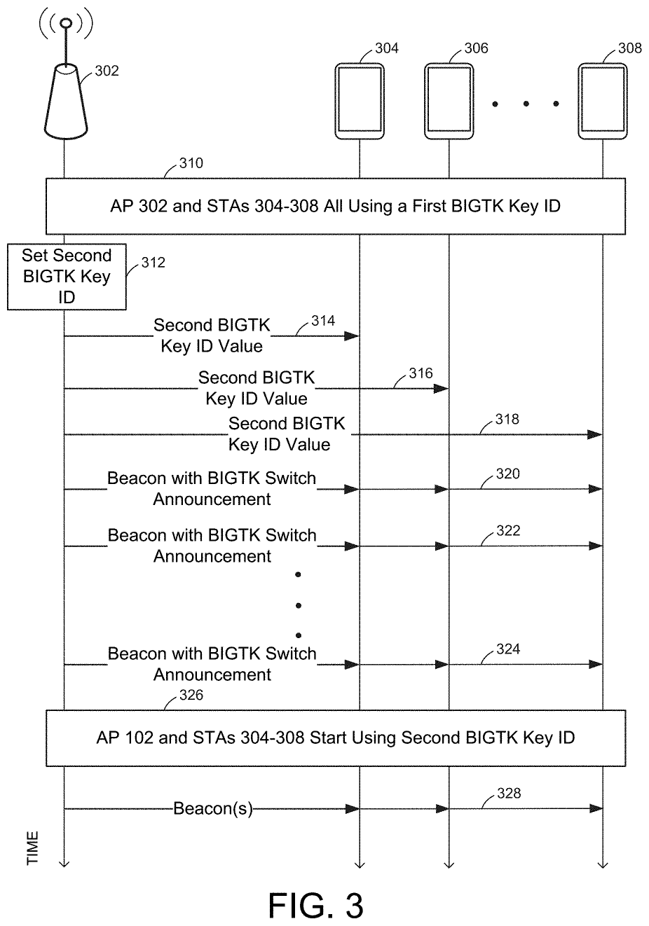

FIG. 3 depicts an illustrative process 300 for switching beacon integrity group temporal keys, in accordance with one or more example embodiments of the present disclosure.

Referring to FIG. 3, an AP 302 may communicate with multiple STAs (e.g., STA 304, STA 306, STA 308). At block 310, the AP 302 and the STAs 304-308 may be using a first BIGTK key ID. At block 312, the AP 302 may set a second (e.g., different) BIGTK key ID to use in communications with the STAs 304-308. However, the STAs 304-308 may not be aware that the AP 302 has set and plans to use the second BIGTK key ID in subsequent communications. The AP 302 may send the second BIGTK key ID value to the STA 304 at step 314, to the STA 306 at step 316, and to the STA 308 at step 318. At step 320, the AP 302 may send a protected beacon (e.g., the beacons 140 of FIG. 1) to the STAs 304-308. The beacon may include a BIGTK switch announcement information element with fields according to Table 1 or to Table 2 below.

TABLE 1
BIGTK Switch Announcement Information
Element for Protected Beacons.

| | | | Element ID | New | BIGTK Switch |
|---|---|---|---|---|---|
| Field | Element ID | Length | Extension | Key ID | Count |
| Length | 1 | 1 | 1 | 1 | 1 |
| (Octets) | | | | | |

As shown in Table 1, the BIGTK switch announcement information element may include an element ID, a length indicator (e.g., for the BIGTK switch announcement information element), an element ID extension indicator, a new key ID (e.g., the new key ID 142 of FIG. 1), and a BIGTK switch count (e.g., the switch count/timestamp 144 of FIG. 1) indicating that the AP 302 will switch to the second BIGTK key ID (e.g., as indicated by the new key ID) after X beacons (e.g., X more beacons until the switch occurs, where X is indicated by the BIGTK switch count). When X is greater than one, the AP 302 may send multiple beacons (e.g., at step 322, step 324, etc.) with the current/old BIGTK, decrementing X by one in each beacon until X is one, meaning that the beacon with the BIGTK switch count field having a value of one (e.g., at step 324) is the final beacon that the AP 302 will send with the current/old BIGTK (e.g., as also included in the beacon), and that the next beacon that the AP 302 will send will include the new BIGTK value as indicated by the new key ID field. In particular, at block 326, after the final beacon using the first BIGTK key ID, the AP 302 and the STAs 304-308 may begin using the second BIGTK key ID (e.g., the new key ID), and subsequent beacons (e.g., at step 328) may include the second BIGTK key ID.

Alternatively, the beacons at steps 320-324 may include a BIGTK switch announcement information element with fields according to Table 2 below.

TABLE 2
BIGTK Switch Announcement Information
Element for Protected Beacons.

| | | | Element ID | New | BIGTK Switch |
|---|---|---|---|---|---|
| Field | Element ID | Length | Extension | Key ID | Timestamp |
| Length | 1 | 1 | 1 | 1 | 3 |
| (Octets) | | | | | |

In contrast with Table 1, instead of using the BIGTK switch count, the beacons at steps 320-324 may include a BIGTK switch timestamp (e.g., the switch count/timestamp 144 of FIG. 1) indicating that the AP 302 will switch to the second BIGTK key ID (e.g., as indicated by the new key ID) after the time expires. The BIGTK switch timestamp may indicate the time when the AP 302 will begin to use the second BIGTK in other beacons (e.g., beginning at the time corresponding to block 326). The BIGTK switch timestamp may be included in multiple beacons (e.g., at steps 320-324) until the switch, so any STA may determine the time remaining until the switch. The BIGTK switch timestamp may be six octets in length, but may only need the three least significant octets when the switch is to occur within a few beacon intervals (e.g., the time between respective beacons). Using the BIGTK switch announcement, the AP 302 may indicate that the AP 302 is going to start using the second key (e.g., indicated by the new key ID field) when a beacon with a BIGTK switch timestamp that is higher than the reported timestamp is received. Starting with a following beacon (e.g., at step 328), protected beacons may be protected with the second BIGTK (e.g., that was indicated by the new key ID field).

In one or more embodiments, instead of using beacons to indicate an upcoming switch from the first key to the second key, the AP 302 may send EAPOL frames (e.g., the EAPOL frames 148) to the STAs 304-308 as shown in FIG. 1. For example, the EAPOL key frame 148 may include multiple fields, such as a key MIC field (not shown), followed by a key data length field (not shown), followed by a key data field 150. When the AP 302 intends to switch to the new BIGTK key (e.g., following the installation/update of new GTK and BIGTK in all STAs), the AP 302 may install the new key in each of the associated STAs 304-308 by transmitting a dedicated BIGTK rekeying EAPOL 148. When installing the new key in the STAs 304-308, the AP 302 may include within the EAPOL frame 148 a new BIGTK Switch Count/Timestamp 154, which may indicate the time when the AP 302 will switch to the new key (e.g., as indicated by the new key ID 152). The BIGTK rekeying EAPOL frame 148 may include an eight-octet key data encapsulation (KDE—used for including data in the EAPOL-key data field 150) that may indicate the time where the AP 302 plans to switch to the new key. Following the BIGTK Switch Count/Timestamp 154, protected beacons (e.g., of the beacons 140) may be protected with the new BIGTK.

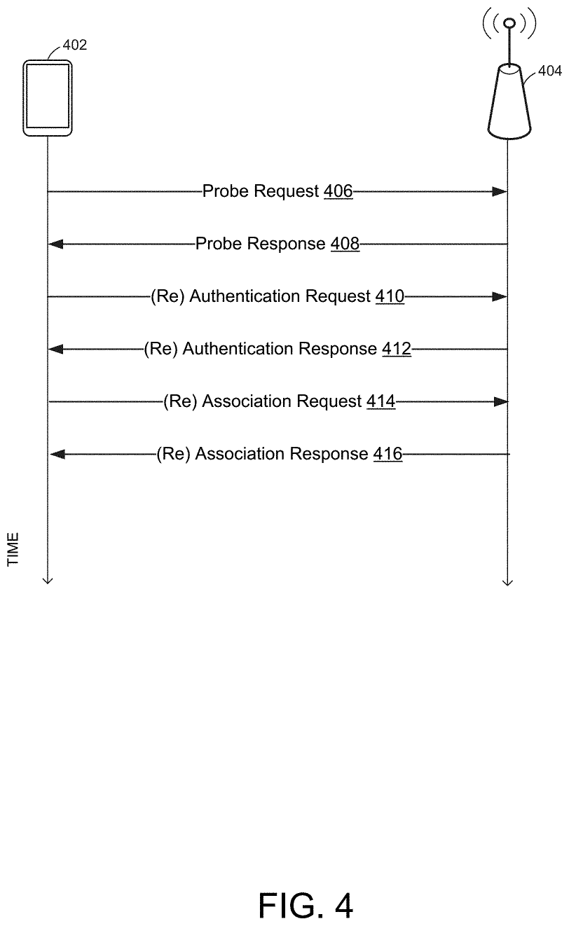

FIG. 4 depicts an illustrative process 400 for device authentication and association, in accordance with one or more example embodiments of the present disclosure.

Referring to FIG. 4, the process 400 for device authentication and association may be used for initial authentication and association, and for subsequent re-authentication and re-association. In particular, a STA 402 may send (e.g., to an AP 404 nearby) a probe request 406 to determine if any area networks (e.g., APs) are nearby. The AP 404 may receive the probe request 406, and may send a probe response 408 to the STA 402 to indicate that the AP 404 is nearby and has one or more networks that the STA 402 may join. The STA 402 may send an authentication request 410 (or re-authentication request if the STA 402 was previously authenticated by the AP 404) to the AP 404, and the AP 404 may send the STA 402 an authentication response 412 (or a re-authentication response if the STA 402 was previously authenticated by the AP 404). The authentication response 412 may indicate whether the STA 402 has been authenticated by the AP 404. When the STA 402 has been authenticated by the AP 404, the STA 402 may send an association request 414 (or re-association request if the STA 402 was previously associated with the AP 404). The AP 404 may receive the association request 414, and may send an association response 416 (or re-association response if the STA 402 was previously associated with the AP 404) to the STA 402 to indicate whether the STA 402 is associated with the AP 404.

Wireless communications defined by the IEEE 802.11 technical standards also may be subjected to attempted attacks, such as man-in-the-middle attacks. One process where attackers (e.g., a different STA 402, such as one of the user devices 120 of FIG. 1) may attempt such an attack is during device association. In particular, attackers may attempt to use a re-association request (e.g., the association request 414) to the AP 404 to perpetrate an attack. For example, the STA 402 previously may have associated with the AP 404, and may need to re-associate with the AP 404. To re-associate, the STA 402 may send a re-authentication request to the AP 404, and once re-authenticated (e.g., as indicated by the re-authentication response 412 sent by the AP 404), the STA 402 may send the re-association request 414 to the AP 404. However, when the AP 404 is unaware that the STA 402 left a service set, the AP 404 may have information indicating that the STA 402 already is associated with the AP 404. Currently, instead of simply rejecting a re-association request, the AP 404 may send a temporary rejection with a ResultCode REFUSED_TEMPORARILY and TimeoutInterval indicating when the STA 402 can try to re-associate again. The AP 404 may provide the temporary rejection because if the AP 404 receives a re-association request from the STA 402, with which the AP 404 has an active security association with active management frame protection, the AP 404 may suspect that the re-association-request 414 was transmitted by a man-in-the-middle and not from the STA 402. However, it is possible that the STA 402 was disconnected from the AP 404 and is trying to re-associate. For this reason, the AP 404 may use the temporary rejection.

In one or more embodiments, to prevent attacks using re-authentication requests, when the AP 404 receives the re-authentication request 410 from the STA 402, the AP 404 temporarily may reject the re-authentication request 410 by including a status code (e.g., the status code field 164 of FIG. 1) and a timeout interval (e.g., the timeout interval field 166 of FIG. 1) in the re-authentication response frame 412 to the STA 402. The status code may include ResultCode REFUSED_TEMPORARILY, and the timeout interval may include a TimeoutInterval indicating when the STA 402 can try to re-associate again. The AP 404 may provide the temporary rejection because if the AP 404 receives the re-association request 414 from an STA with which the AP 404 has an active security association with active management frame protection, the AP 404 may suspect that the re-association-request 414 was transmitted by a man-in-the-middle and not from the previously associated STA.

In one or more embodiments, during the TimeoutInterval indicated by the timeout interval, the AP 404 may apply an SA query procedure: The AP 404 may include in the re-authentication response 412 a protected SA Query Request to the STA, and may wait for an SA Query Response from the STA 402. If an SA Query Response frame (e.g., another re-authentication request after the re-authentication response 412—for example the re-authentication request 410 repeated after the re-authentication response 412) is received by the AP 404, the response indicates that the STA 402 still holds the keys (otherwise, it could not decrypt the protected SA Query Request frame) and is still connected. Also, if an SA Query Response frame is received, the response indicates that the re-authentication request 410 was generated by a man-in-the-middle and should have been rejected. If the re-authentication request 410 was accepted, it may cause the STA 402 to lose sync with the security material, which may result with disconnection (e.g., a simple attack). If a future re-authentication request is received, the AP 404 may reject the request again and repeat the SA Query procedure. If an SA Query Response frame is not received: The STA 402 really lost the keys (e.g., because the keys were lost the STA 402 could not decrypt the protected SA Query message, and as a result, no response was generated). When a future non-protected re-association request is received from the STA 402 (e.g., probably following the TimeoutInterval), the AP 404 may accept the request. As indicated above, using the SA Query procedure in the re-authentication request 410/re-authentication response 412 exchange instead of during the re-association request 414/re-association response 416 exchange, the SQ Query protocol may be more efficient.

It is understood that the above descriptions are for purposes of illustration and are not meant to be limiting.

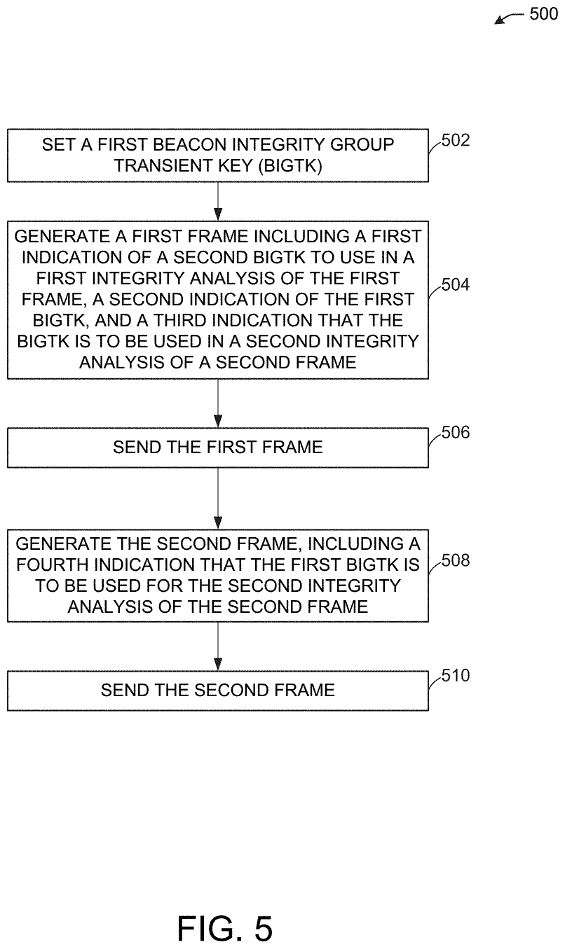

FIG. 5 illustrates a flow diagram of illustrative process 500 for beacon protection rekeying, in accordance with one or more example embodiments of the present disclosure.

At block 502, a device (e.g., the AP 102 of FIG. 1, the AP 302 of FIG. 3) may set a first BIGTK for future use. For example, the device and other devices (e.g., the user devices 120 of FIG. 1, the STAs 304-308 of FIG. 3) may be using a second BIGTK for integrity checks of frames exchanged between the devices (e.g., block 310 of FIG. 3). The device may determine that the second BIGTK (e.g., the currently used BIGTK) is to be switched to the first BIGTK in subsequent communications, and may notify the other devices in advance of the switch.

At block 504, the device may generate a first frame including a first indication of the second BIGTK (e.g., for the other devices to use when performing an integrity check on the first frame, as the device and the other devices have agreed to use the second BIGTK, and the device has not yet informed the other devices of the upcoming switch to the first BIGTK). The first frame also may include a second indication of the first BIGTK and a third indication that the first BIGTK is to be used for integrity checks of a subsequent frame (e.g., second frame) to be sent after the first frame. For example, the first frame may be a beacon (e.g., the beacons 140 of FIG. 1, the beacons at steps 320-324 of FIG. 3) or an EAPOL frame (e.g., the EAPOL frame 148 of FIG. 1). When the first frame is a beacon, the first indication of the currently used BIGTK may be included in a key ID field (e.g., the key ID field 146 of FIG. 1). The second indication of the first BIGTK to be used later may be included in a new key ID field (e.g., the new key ID field 142 of FIG. 1). The third indication may be a timestamp indicating the remaining time before the device will include the second BIGTK for the integrity check, or an indication of a number of additional beacons after the first frame that will include the second BIGTK for the integrity check. The timestamp or number of additional beacons may be included in a switch timestamp or switch count field (e.g., the switch count/timestamp field 144 of FIG. 1, or as shown in Table 1 or Table 2). When the first frame is an EAPOL frame, the EAPOL frame may include a key data field (e.g., the key data field 150 of FIG. 1), which may include a new key ID field (e.g., the new key ID field 152 of FIG. 1) and a switch count or switch timestamp field (e.g., the switch count/timestamp field 154 of FIG. 1) to indicate the first BIGTK and when the first BIGTK is to be used for integrity checks (e.g., a number of frames until the switch occurs, or an amount of time until the switch occurs).

At block 506, the device may send the first frame, which may be received by one or more other devices (e.g., user devices 120 of FIG. 1, the STAs 304-308). The receiving devices may perform an integrity check on the first frame using the second BIGTK, and may be notified of the upcoming switch to the first BIGTK. Depending on the switch timestamp or count, the device may send one or more additional frames relying on the second BIGTK for the integrity before implementing the first BIGTK for the integrity check. When the third indication is a switch count, each subsequent frame after the first frame may decrement the switch count until the count is one or zero (e.g., indicating the final frame to rely on the second BIGTK for the integrity check, and the next frame—the second frame—is to rely on the first BIGTK for the integrity check). When the timestamp is used as the third indication, the timestamp may decrease with each subsequent frame until the second frame is sent and relies on the previously announced first BIGTK for the integrity check.

At block 508, the device may generate the second frame, which may be a beacon, EAPOL, or another type of frame. In this manner, beacons and/or EAPOL frames may be used to announce a BIGTK switch in advance, and the first BIGTK to which the device implements the switch may be used for integrity checks of subsequent frames. The second frame may include a fourth indication that the first BIGTK is to be used for an integrity check of the second frame. The second frame may continue to announce an upcoming BIGTK switch (e.g., a return to the second BIGTK or another BIGTK), or may exclude such announcement information until the device again determines to switch the BIGTK. At block 510, the device may send the second frame, and the receiving devices may use the first BIGTK to perform an integrity check of the second frame.

It is understood that the above descriptions are for purposes of illustration and are not meant to be limiting.

FIG. 6 shows a functional diagram of an exemplary communication station 600, in accordance with one or more example embodiments of the present disclosure. In one embodiment, FIG. 6 illustrates a functional block diagram of a communication station that may be suitable for use as an AP 102 (FIG. 1) or a user device 120 (FIG. 1) in accordance with some embodiments. The communication station 600 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 600 may include communications circuitry 602 and a transceiver 610 for transmitting and receiving signals to and from other communication stations using one or more antennas 601. The communications circuitry 602 may include circuitry that can operate the physical layer (PHY) communications and/or medium access control (MAC) communications for controlling access to the wireless medium, and/or any other communications layers for transmitting and receiving signals. The communication station 600 may also include processing circuitry 606 and memory 608 arranged to perform the operations described herein. In some embodiments, the communications circuitry 602 and the processing circuitry 606 may be configured to perform operations detailed in the above figures, diagrams, and flows.

In accordance with some embodiments, the communications circuitry 602 may be arranged to contend for a wireless medium and configure frames or packets for communicating over the wireless medium. The communications circuitry 602 may be arranged to transmit and receive signals. The communications circuitry 602 may also include circuitry for modulation/demodulation, upconversion/downconversion, filtering, amplification, etc. In some embodiments, the processing circuitry 606 of the communication station 600 may include one or more processors. In other embodiments, two or more antennas 601 may be coupled to the communications circuitry 602 arranged for sending and receiving signals. The memory 608 may store information for configuring the processing circuitry 606 to perform operations for configuring and transmitting message frames and performing the various operations described herein. The memory 608 may include any type of memory, including non-transitory memory, for storing information in a form readable by a machine (e.g., a computer). For example, the memory 608 may include a computer-readable storage device, read-only memory (ROM), random-access memory (RAM), magnetic disk storage media, optical storage media, flash-memory devices and other storage devices and media.

In some embodiments, the communication station 600 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 600 may include one or more antennas 601. The antennas 601 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 600 may include one or more of a keyboard, a display, a non-volatile memory port, multiple antennas, a graphics processor, an application processor, speakers, and other mobile device elements. The display may be an LCD screen including a touch screen.

Although the communication station 600 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 600 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 600 may include one or more processors and may be configured with instructions stored on a computer-readable storage device.

FIG. 7 illustrates a block diagram of an example of a machine 700 or system upon which any one or more of the techniques (e.g., methodologies) discussed herein may be performed. In other embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environments. The machine 700 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a power management device 732, a graphics display device 710, an alphanumeric input device 712 (e.g., a keyboard), and a user interface (UI) navigation device 714 (e.g., a mouse). In an example, the graphics display device 710, alphanumeric input device 712, and UI navigation device 714 may be a touch screen display. The machine 700 may additionally include a storage device (i.e., drive unit) 716, a signal generation device 718 (e.g., a speaker), an enhanced rekeying and detection device 719, a network interface device/transceiver 720 coupled to antenna(s) 730, and one or more sensors 728, such as a global positioning system (GPS) sensor, a compass, an accelerometer, or other sensor. The machine 700 may include an output controller 734, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 702 for generation and processing of the baseband signals and for controlling operations of the main memory 704, the storage device 716, and/or the enhanced rekeying and detection device 719. The baseband processor may be provided on a single radio card, a single chip, or an integrated circuit (IC).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within the static memory 706, or within the hardware processor 702 during execution thereof by the machine 700. In an example, one or any combination of the hardware processor 702, the main memory 704, the static memory 706, or the storage device 716 may constitute machine-readable media.

The enhanced rekeying and detection device 719 may carry out or perform any of the operations and processes (e.g., process XY00) described and shown above.

It is understood that the above are only a subset of what the enhanced rekeying and detection device 719 may be configured to perform and that other functions included throughout this disclosure may also be performed by the enhanced rekeying and detection device 719.

While the machine-readable medium 722 is illustrated as a single medium, the term “machine-readable medium” may include a single medium or multiple media (e.g., a centralized or distributed database, and/or associated caches and servers) configured to store the one or more instructions 724.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 700 and that cause the machine 700 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device/transceiver 720 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 720 may include one or more physical jacks (e.g., Ethernet, coaxial, or phone jacks) or one or more antennas to connect to the communications network 726. In an example, the network interface device/transceiver 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 700 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

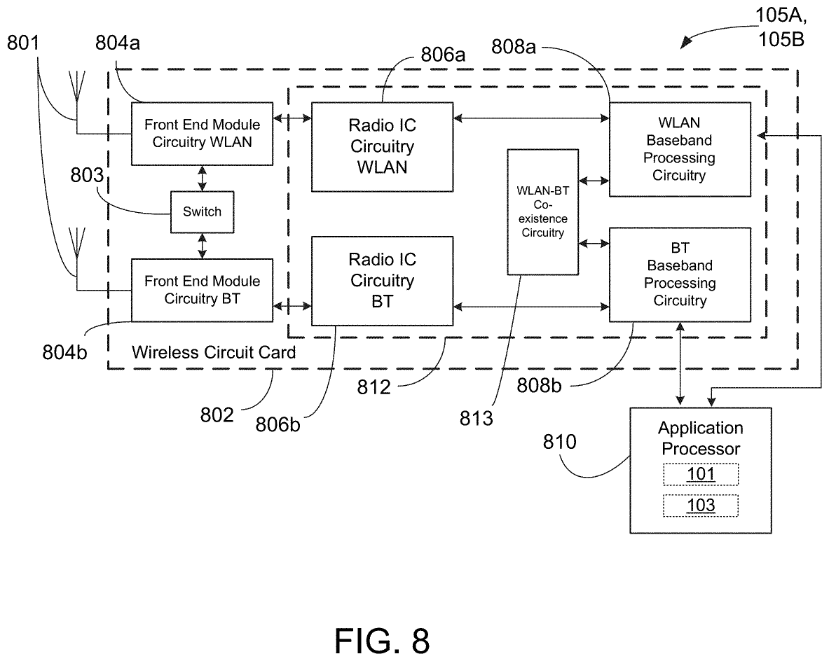

FIG. 8 is a block diagram of a radio architecture 105A, 105B in accordance with some embodiments that may be implemented in any one of the example AP 102 and/or the example STA 120 of FIG. 1. Radio architecture 105A, 105B may include radio front-end module (FEM) circuitry 804a-b, radio IC circuitry 806a-b and baseband processing circuitry 808a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 804a-b may include a WLAN or Wi-Fi FEM circuitry 804a and a Bluetooth (BT) FEM circuitry 804b. The WLAN FEM circuitry 804a may include a receive signal path comprising circuitry configured to operate on WLAN RF signals received from one or more antennas 801, to amplify the received signals and to provide the amplified versions of the received signals to the WLAN radio IC circuitry 806a for further processing. The BT FEM circuitry 804b may include a receive signal path which may include circuitry configured to operate on BT RF signals received from one or more antennas 801, to amplify the received signals and to provide the amplified versions of the received signals to the BT radio IC circuitry 806b for further processing. FEM circuitry 804a may also include a transmit signal path which may include circuitry configured to amplify WLAN signals provided by the radio IC circuitry 806a for wireless transmission by one or more of the antennas 801. In addition, FEM circuitry 804b may also include a transmit signal path which may include circuitry configured to amplify BT signals provided by the radio IC circuitry 806b for wireless transmission by the one or more antennas. In the embodiment of FIG. 8, although FEM 804a and FEM 804b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 806a-b as shown may include WLAN radio IC circuitry 806a and BT radio IC circuitry 806b. The WLAN radio IC circuitry 806a may include a receive signal path which may include circuitry to down-convert WLAN RF signals received from the FEM circuitry 804a and provide baseband signals to WLAN baseband processing circuitry 808a. BT radio IC circuitry 806b may in turn include a receive signal path which may include circuitry to down-convert BT RF signals received from the FEM circuitry 804b and provide baseband signals to BT baseband processing circuitry 808b. WLAN radio IC circuitry 806a may also include a transmit signal path which may include circuitry to up-convert WLAN baseband signals provided by the WLAN baseband processing circuitry 808a and provide WLAN RF output signals to the FEM circuitry 804a for subsequent wireless transmission by the one or more antennas 801. BT radio IC circuitry 806b may also include a transmit signal path which may include circuitry to up-convert BT baseband signals provided by the BT baseband processing circuitry 808b and provide BT RF output signals to the FEM circuitry 804b for subsequent wireless transmission by the one or more antennas 801. In the embodiment of FIG. 8, although radio IC circuitries 806a and 806b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 808a-b may include a WLAN baseband processing circuitry 808a and a BT baseband processing circuitry 808b. The WLAN baseband processing circuitry 808a may include a memory, such as, for example, a set of RAM arrays in a Fast Fourier Transform or Inverse Fast Fourier Transform block (not shown) of the WLAN baseband processing circuitry 808a. Each of the WLAN baseband circuitry 808a and the BT baseband circuitry 808b may further include one or more processors and control logic to process the signals received from the corresponding WLAN or BT receive signal path of the radio IC circuitry 806a-b, and to also generate corresponding WLAN or BT baseband signals for the transmit signal path of the radio IC circuitry 806a-b. Each of the baseband processing circuitries 808a and 808b may further include physical layer (PHY) and medium access control layer (MAC) circuitry, and may further interface with a device for generation and processing of the baseband signals and for controlling operations of the radio IC circuitry 806a-b.

Referring still to FIG. 8, according to the shown embodiment, WLAN-BT coexistence circuitry 813 may include logic providing an interface between the WLAN baseband circuitry 808a and the BT baseband circuitry 808b to enable use cases requiring WLAN and BT coexistence. In addition, a switch 803 may be provided between the WLAN FEM circuitry 804a and the BT FEM circuitry 804b to allow switching between the WLAN and BT radios according to application needs. In addition, although the antennas 801 are depicted as being respectively connected to the WLAN FEM circuitry 804a and the BT FEM circuitry 804b, embodiments include within their scope the sharing of one or more antennas as between the WLAN and BT FEMs, or the provision of more than one antenna connected to each of FEM 804a or 804b.

In some embodiments, the front-end module circuitry 804a-b, the radio IC circuitry 806a-b, and baseband processing circuitry 808a-b may be provided on a single radio card, such as wireless radio card 802. In some other embodiments, the one or more antennas 801, the FEM circuitry 804a-b and the radio IC circuitry 806a-b may be provided on a single radio card. In some other embodiments, the radio IC circuitry 806a-b and the baseband processing circuitry 808a-b may be provided on a single chip or integrated circuit (IC), such as IC 812.

In some embodiments, the wireless radio card 802 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11 ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 8, the BT baseband circuitry 808b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. However, the scope of the embodiments is not limited with respect to the above center frequencies.

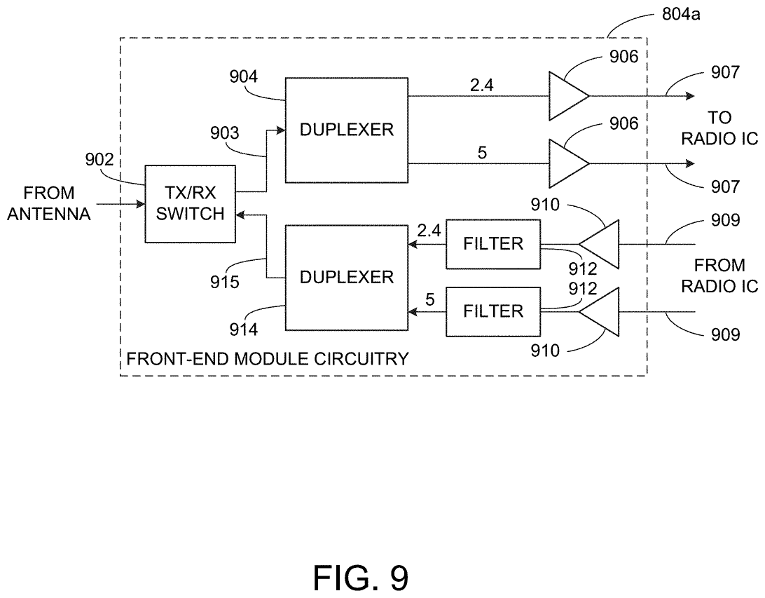

FIG. 9 illustrates WLAN FEM circuitry 804a in accordance with some embodiments. Although the example of FIG. 9 is described in conjunction with the WLAN FEM circuitry 804a, the example of FIG. 9 may be described in conjunction with the example BT FEM circuitry 804b (FIG. 8), although other circuitry configurations may also be suitable.

In some embodiments, the FEM circuitry 804a may include a TX/RX switch 902 to switch between transmit mode and receive mode operation. The FEM circuitry 804a may include a receive signal path and a transmit signal path. The receive signal path of the FEM circuitry 804a may include a low-noise amplifier (LNA) 906 to amplify received RF signals 903 and provide the amplified received RF signals 907 as an output (e.g., to the radio IC circuitry 806a-b (FIG. 8)). The transmit signal path of the circuitry 804a may include a power amplifier (PA) to amplify input RF signals 909 (e.g., provided by the radio IC circuitry 806a-b), and one or more filters 912, such as band-pass filters (BPFs), low-pass filters (LPFs) or other types of filters, to generate RF signals 915 for subsequent transmission (e.g., by one or more of the antennas 801 (FIG. 8)) via an example duplexer 914.

In some dual-mode embodiments for Wi-Fi communication, the FEM circuitry 804a may be configured to operate in either the 2.4 GHz frequency spectrum or the 5 GHz frequency spectrum. In these embodiments, the receive signal path of the FEM circuitry 804a may include a receive signal path duplexer 904 to separate the signals from each spectrum as well as provide a separate LNA 906 for each spectrum as shown. In these embodiments, the transmit signal path of the FEM circuitry 804a may also include a power amplifier 910 and a filter 912, such as a BPF, an LPF or another type of filter for each frequency spectrum and a transmit signal path duplexer 904 to provide the signals of one of the different spectrums onto a single transmit path for subsequent transmission by the one or more of the antennas 801 (FIG. 8). In some embodiments, BT communications may utilize the 2.4 GHz signal paths and may utilize the same FEM circuitry 804a as the one used for WLAN communications.

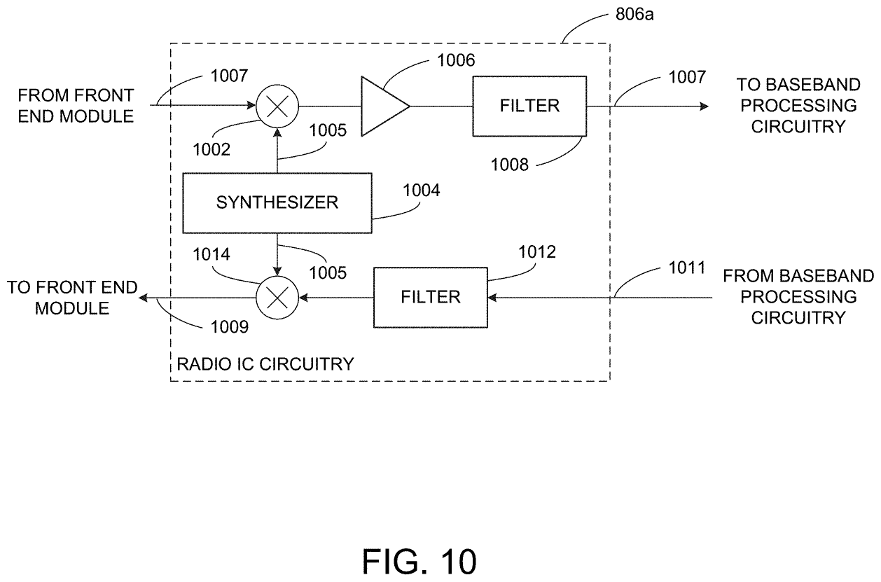

FIG. 10 illustrates radio IC circuitry 806a in accordance with some embodiments. The radio IC circuitry 806a is one example of circuitry that may be suitable for use as the WLAN or BT radio IC circuitry 806a/806b (FIG. 8), although other circuitry configurations may also be suitable. Alternatively, the example of FIG. 10 may be described in conjunction with the example BT radio IC circuitry 806b.

In some embodiments, the radio IC circuitry 806a may include a receive signal path and a transmit signal path. The receive signal path of the radio IC circuitry 806a may include at least mixer circuitry 1002, such as, for example, down-conversion mixer circuitry, amplifier circuitry 1006 and filter circuitry 1008. The transmit signal path of the radio IC circuitry 806a may include at least filter circuitry 1012 and mixer circuitry 1014, such as, for example, up-conversion mixer circuitry. Radio IC circuitry 806a may also include synthesizer circuitry 1004 for synthesizing a frequency 1005 for use by the mixer circuitry 1002 and the mixer circuitry 1014. The mixer circuitry 1002 and/or 1014 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 10 illustrates only a simplified version of a radio IC circuitry, and may include, although not shown, embodiments where each of the depicted circuitries may include more than one component. For instance, mixer circuitry 1014 may each include one or more mixers, and filter circuitries 1008 and/or 1012 may each include one or more filters, such as one or more BPFs and/or LPFs according to application needs. For example, when mixer circuitries are of the direct-conversion type, they may each include two or more mixers.

In some embodiments, mixer circuitry 1002 may be configured to down-convert RF signals XZY07 received from the FEM circuitry 804a-b (FIG. 8) based on the synthesized frequency 1005 provided by synthesizer circuitry 1004. The amplifier circuitry 1006 may be configured to amplify the down-converted signals and the filter circuitry 1008 may include an LPF configured to remove unwanted signals from the down-converted signals to generate output baseband signals 1007. Output baseband signals 1007 may be provided to the baseband processing circuitry 808a-b (FIG. 8) for further processing. In some embodiments, the output baseband signals 1007 may be zero-frequency baseband signals, although this is not a requirement. In some embodiments, mixer circuitry 1002 may comprise passive mixers, although the scope of the embodiments is not limited in this respect.

In some embodiments, the mixer circuitry 1014 may be configured to up-convert input baseband signals 1011 based on the synthesized frequency 1005 provided by the synthesizer circuitry 1004 to generate RF output signals XZY09 for the FEM circuitry 804a-b. The baseband signals 1011 may be provided by the baseband processing circuitry 808a-b and may be filtered by filter circuitry 1012. The filter circuitry 1012 may include an LPF or a BPF, although the scope of the embodiments is not limited in this respect.

In some embodiments, the mixer circuitry 1002 and the mixer circuitry 1014 may each include two or more mixers and may be arranged for quadrature down-conversion and/or up-conversion respectively with the help of synthesizer 1004. In some embodiments, the mixer circuitry 1002 and the mixer circuitry 1014 may each include two or more mixers each configured for image rejection (e.g., Hartley image rejection). In some embodiments, the mixer circuitry 1002 and the mixer circuitry 1014 may be arranged for direct down-conversion and/or direct up-conversion, respectively. In some embodiments, the mixer circuitry 1002 and the mixer circuitry 1014 may be configured for super-heterodyne operation, although this is not a requirement.

Mixer circuitry 1002 may comprise, according to one embodiment: quadrature passive mixers (e.g., for the in-phase (I) and quadrature phase (Q) paths). In such an embodiment, RF input signal XZY07 from FIG. 10 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1005 of synthesizer 1004 (FIG. 10). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal XZY07 (FIG. XZY) may comprise a balanced signal, although the scope of the embodiments is not limited in this respect. The I and Q baseband output signals may be provided to low-noise amplifier, such as amplifier circuitry 1006 (FIG. 10) or to filter circuitry 1008 (FIG. 10).

In some embodiments, the output baseband signals 1007 and the input baseband signals 1011 may be analog baseband signals, although the scope of the embodiments is not limited in this respect. In some alternate embodiments, the output baseband signals 1007 and the input baseband signals 1011 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1004 may be a fractional-N synthesizer or a fractional N/N+1 synthesizer, although the scope of the embodiments is not limited in this respect as other types of frequency synthesizers may be suitable. For example, synthesizer circuitry 1004 may be a delta-sigma synthesizer, a frequency multiplier, or a synthesizer comprising a phase-locked loop with a frequency divider. According to some embodiments, the synthesizer circuitry 1004 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1004 may be provided by a voltage controlled oscillator (VCO), although that is not a requirement. A divider control input may further be provided by either the baseband processing circuitry 808a-b (FIG. 8) depending on the desired output frequency 1005. In some embodiments, a divider control input (e.g., N) may be determined from a look-up table (e.g., within a Wi-Fi card) based on a channel number and a channel center frequency as determined or indicated by the example application processor 810. The application processor 810 may include, or otherwise be connected to, one of the example secure signal converter 101 or the example received signal converter 103 (e.g., depending on which device the example radio architecture is implemented in).

In some embodiments, synthesizer circuitry 1004 may be configured to generate a carrier frequency as the output frequency 1005, while in other embodiments, the output frequency 1005 may be a fraction of the carrier frequency (e.g., one-half the carrier frequency, one-third the carrier frequency). In some embodiments, the output frequency 1005 may be a LO frequency (fLO).

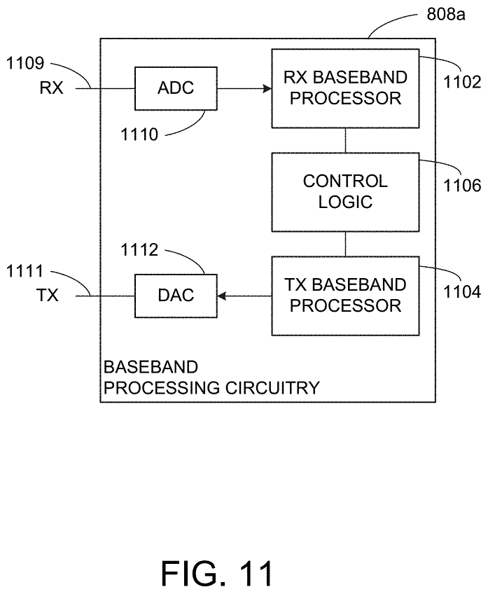

FIG. 11 illustrates a functional block diagram of baseband processing circuitry 808a in accordance with some embodiments. The baseband processing circuitry 808a is one example of circuitry that may be suitable for use as the baseband processing circuitry 808a (FIG. 8), although other circuitry configurations may also be suitable. Alternatively, the example of FIG. 10 may be used to implement the example BT baseband processing circuitry 808b of FIG. 8.

The baseband processing circuitry 808a may include a receive baseband processor (RX BBP) 1102 for processing receive baseband signals 1009 provided by the radio IC circuitry 806a-b (FIG. 8) and a transmit baseband processor (TX BBP) 1104 for generating transmit baseband signals 1011 for the radio IC circuitry 806a-b. The baseband processing circuitry 808a may also include control logic 1106 for coordinating the operations of the baseband processing circuitry 808a.

In some embodiments (e.g., when analog baseband signals are exchanged between the baseband processing circuitry 808a-b and the radio IC circuitry 806a-b), the baseband processing circuitry 808a may include ADC 1110 to convert analog baseband signals 1109 received from the radio IC circuitry 806a-b to digital baseband signals for processing by the RX BBP 1102. In these embodiments, the baseband processing circuitry 808a may also include DAC 1112 to convert digital baseband signals from the TX BBP 1104 to analog baseband signals 1111.

In some embodiments that communicate OFDM signals or OFDMA signals, such as through baseband processor 808a, the transmit baseband processor 1104 may be configured to generate OFDM or OFDMA signals as appropriate for transmission by performing an inverse fast Fourier transform (IFFT). The receive baseband processor 1102 may be configured to process received OFDM signals or OFDMA signals by performing an FFT. In some embodiments, the receive baseband processor 1102 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 8, in some embodiments, the antennas 801 (FIG. 8) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 801 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MIS 0) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Example 1 may be a device comprising memory and processing circuitry configured to: set a first beacon integrity group transient key (BIGTK); generate a first frame comprising a first indication of a second BIGTK to be used for a first integrity analysis of the first frame, a second indication of the first BIGTK, and a third indication that the first BIGTK is to be used for a second integrity analysis of a second frame to be sent after the first frame; send the first frame; generate the second frame, the second frame comprising a fourth indication that the first BIGTK is to be used for the second integrity analysis of the second frame; and send the second frame.

Example 2 may include the device of example 1 and/or some other example herein, wherein the first frame is a first beacon frame, wherein the second frame is a second beacon frame, and wherein the third indication comprises a switch count indicative of a number of beacon frames to be sent after the first beacon frame and before the second beacon frame, the number of beacon frames comprising the first indication of the second BIGTK to be used for integrity analyses of the number of beacon frames.

Example 3 may include the device of example 2 and/or some other example herein, wherein the switch count is two, wherein the number of beacon frames is one, and wherein the processing circuitry is further configured to: generate a third beacon frame comprising the first indication of the second BIGTK to be used for a third integrity analysis of the third beacon frame, the second indication of the first BIGTK, and a fifth indication of a second switch count, wherein the second switch count is one; and send the third beacon frame after the first beacon frame and before the second beacon frame.

Example 4 may include the device of example 2 and/or some other example herein, wherein the switch count is one, and wherein the number of beacon frames is zero.

Example 5 may include the device of example 1 and/or some other example herein, wherein the first frame is a first beacon frame, wherein the second frame is a second beacon frame, and wherein the third indication comprises a timestamp indicative of an amount of time before the device is to include the first BIGTK to use for the second integrity analysis of the second beacon frame.

Example 6 may include the device of example 5 and/or some other example herein, wherein the amount of time is greater than zero, and wherein the processing circuitry is further configured to: generate a third beacon frame comprising the first indication of the second BIGTK to be used for a third integrity analysis of the third beacon frame, the second indication of the first BIGTK, and a fifth indication of a second timestamp, wherein a second amount of time indicated by the second timestamp is less than the amount of time; and send the third beacon frame after the first beacon frame and before the second beacon frame.

Example 7 may include the device of example 1 and/or some other example herein, The device of claim 1, wherein the first frame is an extensible authentication protocol over local area network (EAPOL) frame, and wherein the second frame is a beacon frame.

Example 8 may include the device of example 1 and/or some other example herein, further comprising a transceiver configured to transmit and receive wireless signals.

Example 9 may include the device of example 8 and/or some other example herein, further comprising one or more antennas coupled to the transceiver.

Example 10 may include a non-transitory computer-readable medium storing computer-executable instructions which when executed by one or more processors result in performing operations comprising: setting, by a device, a first beacon integrity group transient key (BIGTK); generating a first frame comprising a first indication of a second BIGTK to be used for a first integrity analysis of the first frame, a second indication of the first BIGTK, and a third indication that the first BIGTK is to be used for a second integrity analysis of a second frame to be sent after the first frame; sending the first frame; generating the second frame, the second frame comprising a fourth indication that the first BIGTK is to be used for the second integrity analysis of the second frame; and sending the second frame.

Example 11 may include the non-transitory computer-readable medium of example 10 and/or some other example herein, wherein the first frame is a first beacon frame, wherein the second frame is a second beacon frame, and wherein the third indication comprises a switch count indicative of a number of beacon frames to be sent after the first beacon frame and before the second beacon frame, the number of beacon frames comprising the first indication of the second BIGTK to be used for integrity analyses of the number of beacon frames.

Example 12 may include the non-transitory computer-readable medium of example 11 and/or some other example herein, wherein the switch count is two, wherein the number of beacon frames is one, and wherein the operations further comprise: generating a third beacon frame comprising the first indication of the second BIGTK to be used for a third integrity analysis of the third beacon frame, the second indication of the first BIGTK, and a fifth indication of a second switch count, wherein the second switch count is one; and sending the third beacon frame after the first beacon frame and before the second beacon frame.

Example 13 may include the non-transitory computer-readable medium of example 11 and/or some other example herein, wherein the switch count is one, and wherein the number of beacon frames is zero.

Example 14 may include the non-transitory computer-readable medium of example 10 and/or some other example herein, wherein the first frame is a first beacon frame, wherein the second frame is a second beacon frame, and wherein the third indication comprises a timestamp indicative of an amount of time before the device is to include the first BIGTK to use for the second integrity analysis of the second beacon frame.

Example 15 may include the non-transitory computer-readable medium of example 14 and/or some other example herein, wherein the amount of time is greater than zero, and wherein the operations further comprise: generating a third beacon frame comprising the first indication of the second BIGTK to be used for a third integrity analysis of the third beacon frame, the second indication of the first BIGTK, and a fifth indication of a second timestamp, wherein a second amount of time indicated by the second timestamp is less than the amount of time; and sending the third beacon frame after the first beacon frame and before the second beacon frame.

Example 16 may include the non-transitory computer-readable medium of example 14 and/or some other example herein, wherein the first frame is an extensible authentication protocol over local area network (EAPOL) frame, and wherein the second frame is a beacon frame.

Example 17 may include a method comprising: setting, by processing circuitry of a device, a first beacon integrity group transient key (BIGTK); generating, by the processing circuitry, a first frame comprising a first indication of a second BIGTK to be used for a first integrity analysis of the first frame, a second indication of the first BIGTK, and a third indication that the first BIGTK is to be used for a second integrity analysis of a second frame to be sent after the first frame; sending, by the processing circuitry, the first frame; generating, by the processing circuitry, the second frame, the second frame comprising a fourth indication that the first BIGTK is to be used for the second integrity analysis of the second frame; and sending, by the processing circuitry, the second frame.

Example 18 may include the method of example 17 and/or some other example herein, wherein the first frame is a first beacon frame, wherein the second frame is a second beacon frame, and wherein the third indication comprises a switch count indicative of a number of beacon frames to be sent after the first beacon frame and before the second beacon frame, the number of beacon frames comprising the first indication of the second BIGTK to be used for integrity analyses of the number of beacon frames.

Example 19 may include the method of example 18 and/or some other example herein, wherein the switch count is two, wherein the number of beacon frames is one, and wherein the method further comprises: generating a third beacon frame comprising the first indication of the second BIGTK to be used for a third integrity analysis of the third beacon frame, the second indication of the first BIGTK, and a fifth indication of a second switch count, wherein the second switch count is one; and sending the third beacon frame after the first beacon frame and before the second beacon frame.

Example, 20 may include the method of example 18 and/or some other example herein, wherein the switch count is one, and wherein the number of beacon frames is zero.

Example 21 may include an apparatus comprising means for: setting, a device, a first beacon integrity group transient key (BIGTK); generating a first frame comprising a first indication of a second BIGTK to be used for a first integrity analysis of the first frame, a second indication of the first BIGTK, and a third indication that the first BIGTK is to be used for a second integrity analysis of a second frame to be sent after the first frame; sending the first frame; generating the second frame, the second frame comprising a fourth indication that the first BIGTK is to be used for the second integrity analysis of the second frame; and sending the second frame.

Example 22 may include one or more non-transitory computer-readable media comprising instructions to cause an electronic device, upon execution of the instructions by one or more processors of the electronic device, to perform one or more elements of a method described in or related to any of examples 1-21, or any other method or process described herein.

Example 23 may include an apparatus comprising logic, modules, and/or circuitry to perform one or more elements of a method described in or related to any of examples 1-21, or any other method or process described herein.

Example 24 may include a method, technique, or process as described in or related to any of examples 1-21, or portions or parts thereof.

Example 25 may include an apparatus comprising: one or more processors and one or more computer readable media comprising instructions that, when executed by the one or more processors, cause the one or more processors to perform the method, techniques, or process as described in or related to any of examples 1-21, or portions thereof.

Example 26 may include a method of communicating in a wireless network as shown and described herein.

Example 27 may include a system for providing wireless communication as shown and described herein.

Example 28 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, the device comprising processing circuitry coupled to storage, the processing circuitry configured to:
set a first beacon integrity group transient key (BIGTK);
generate a first frame comprising a first indication of a second BIGTK to be used for a first integrity analysis of the first frame, a second indication of the first BIGTK, and a third indication that the first BIGTK is to be used for a second integrity analysis of a second frame to be sent after the first frame;
send the first frame;
generate the second frame, the second frame comprising a fourth indication that the first BIGTK is to be used for the second integrity analysis of the second frame; and
send the second frame.

2. The device of claim 1, wherein the first frame is a first beacon frame, wherein the second frame is a second beacon frame, and wherein the third indication comprises a switch count indicative of a number of beacon frames to be sent after the first beacon frame and before the second beacon frame, the number of beacon frames comprising the first indication of the second BIGTK to be used for integrity analyses of the number of beacon frames.

3. The device of claim 2, wherein the switch count is two, wherein the number of beacon frames is one, and wherein the processing circuitry is further configured to:
generate a third beacon frame comprising the first indication of the second BIGTK to be used for a third integrity analysis of the third beacon frame, the second indication of the first BIGTK, and a fifth indication of a second switch count, wherein the second switch count is one; and
send the third beacon frame after the first beacon frame and before the second beacon frame.

4. The device of claim 2, wherein the switch count is one, and wherein the number of beacon frames is zero.

5. The device of claim 1, wherein the first frame is a first beacon frame, wherein the second frame is a second beacon frame, and wherein the third indication comprises a timestamp indicative of an amount of time before the device is to include the first BIGTK to use for the second integrity analysis of the second beacon frame.

6. The device of claim 5, wherein the amount of time is greater than zero, and wherein the processing circuitry is further configured to:
generate a third beacon frame comprising the first indication of the second BIGTK to be used for a third integrity analysis of the third beacon frame, the second indication of the first BIGTK, and a fifth indication of a second timestamp, wherein a second amount of time indicated by the second timestamp is less than the amount of time; and
send the third beacon frame after the first beacon frame and before the second beacon frame.

7. The device of claim 1, wherein the first frame is an extensible authentication protocol over local area network (EAPOL) frame, and wherein the second frame is a beacon frame.

8. The device of claim 1, further comprising a transceiver configured to transmit and receive wireless signals comprising the first frame and the second frame.

9. The device of claim 8, further comprising an antenna coupled to the transceiver to send the first frame and the second frame.

10. A non-transitory computer-readable medium storing computer-executable instructions which when executed by one or more processors result in performing operations comprising:
setting, by a device, a first beacon integrity group transient key (BIGTK);
generating a first frame comprising a first indication of a second BIGTK to be used for a first integrity analysis of the first frame, a second indication of the first BIGTK, and a third indication that the first BIGTK is to be used for a second integrity analysis of a second frame to be sent after the first frame;
sending the first frame;
generating the second frame, the second frame comprising a fourth indication that the first BIGTK is to be used for the second integrity analysis of the second frame; and
sending the second frame.

11. The transitory computer-readable medium of claim 10, wherein the first frame is a first beacon frame, wherein the second frame is a second beacon frame, and wherein the third indication comprises a switch count indicative of a number of beacon frames to be sent after the first beacon frame and before the second beacon frame, the number of beacon frames comprising the first indication of the second BIGTK to be used for integrity analyses of the number of beacon frames.

12. The transitory computer-readable medium of claim 11, wherein the switch count is two, wherein the number of beacon frames is one, and wherein the operations further comprise:
generating a third beacon frame comprising the first indication of the second BIGTK to be used for a third integrity analysis of the third beacon frame, the second indication of the first BIGTK, and a fifth indication of a second switch count, wherein the second switch count is one; and
sending the third beacon frame after the first beacon frame and before the second beacon frame.

13. The transitory computer-readable medium of claim 11, wherein the switch count is one, and wherein the number of beacon frames is zero.

14. The transitory computer-readable medium of claim 10, wherein the first frame is a first beacon frame, wherein the second frame is a second beacon frame, and wherein the third indication comprises a timestamp indicative of an amount of time before the device is to include the first BIGTK to use for the second integrity analysis of the second beacon frame.

15. The transitory computer-readable medium of claim 14, wherein the amount of time is greater than zero, and wherein the operations further comprise:
generating a third beacon frame comprising the first indication of the second BIGTK to be used for a third integrity analysis of the third beacon frame, the second indication of the first BIGTK, and a fifth indication of a second timestamp, wherein a second amount of time indicated by the second timestamp is less than the amount of time; and
sending the third beacon frame after the first beacon frame and before the second beacon frame.

16. The transitory computer-readable medium of claim 10, wherein the first frame is an extensible authentication protocol over local area network (EAPOL) frame, and wherein the second frame is a beacon frame.

17. A method comprising:
setting, by processing circuitry of a device, a first beacon integrity group transient key (BIGTK);
generating, by the processing circuitry, a first frame comprising a first indication of a second BIGTK to be used for a first integrity analysis of the first frame, a second indication of the first BIGTK, and a third indication that the first BIGTK is to be used for a second integrity analysis of a second frame to be sent after the first frame;
sending, by the processing circuitry, the first frame;
generating, by the processing circuitry, the second frame, the second frame comprising a fourth indication that the first BIGTK is to be used for the second integrity analysis of the second frame; and
sending, by the processing circuitry, the second frame.

18. The method of claim 17, wherein the first frame is a first beacon frame, wherein the second frame is a second beacon frame, and wherein the third indication comprises a switch count indicative of a number of beacon frames to be sent after the first beacon frame and before the second beacon frame, the number of beacon frames comprising the first indication of the second BIGTK to be used for integrity analyses of the number of beacon frames.

19. The method of claim 18, wherein the switch count is two, wherein the number of beacon frames is one, and wherein the method further comprises:
generating a third beacon frame comprising the first indication of the second BIGTK to be used for a third integrity analysis of the third beacon frame, the second indication of the first BIGTK, and a fifth indication of a second switch count, wherein the second switch count is one; and
sending the third beacon frame after the first beacon frame and before the second beacon frame.

20. The method of claim 18, wherein the switch count is one, and wherein the number of beacon frames is zero.
